(19) United States
(12) Patent Application Publication
(10) Pub. No.: US 2023/0123220 A1
(43) Pub. Date: Apr. 20, 2023

(54) TRANSMISSION MECHANISM, SHEET-TYPE MEDIUM PROCESSING DEVICE, AND CASH RECYCLER MACHINE

(71) Applicant: Shandong New Beiyang Information Technology Co., Ltd., Shandong (CN)

(72) Inventors: Haiyang Liang, Shandong (CN); Qiangzi Cong, Shandong (CN); Jianyu Sun, Shandong (CN); Chuntao Wang, Shandong (CN)

(21) Appl. No.: 17/788,638

(22) PCT Filed: Sep. 21, 2020
(86) PCT No.: PCT/CN2020/116572

§ 371 Date: Dec. 16, 2022

(30) Foreign Application Priority Data
Dec. 23, 2019 (CN) 201911353295.X

(51) Int. Cl. G07D 11/16; B65H 29/38

(52) U.S. Cl. CPC G07D 11/16; B65H 29/38; B65H 2403/41; B65H 2701/1912; G07D 2211/00

(57) ABSTRACT

Provided are a transmission mechanism, a sheet-type medium processing device, and an automatic teller machine. The transmission mechanism includes a first frame (100), a second frame (200), and a transmission assembly; the transmission assembly includes a mounting frame (310), a first transmission member (330), a second transmission member (340), and an elastic member (320). The mounting frame (310) is movably disposed on the first frame (100), the first transmission member (330) is disposed on the mounting frame(310), the second transmission member (340) is disposed on the second frame (200), the elastic member (320) is connected between the mounting frame (310) and the first frame (100), and the elastic member (320) is configured to enable the mounting frame (310) to drive the first transmission member (330) to move in a set direction, so that the first transmission member (330) is mated with the second transmission member (340).

The present disclosure claims priority to Chinese Patent Application No. 201911353295.X, filed with the China National Intellectual Property Administration (CNIPA) on Dec. 23, 2019, the disclosure of which is hereby incorporated by reference in its entirety.

### TECHNICAL FIELD

The present disclosure relates to the technical field of self-service equipment, for example, a transmission mechanism, a sheet-type medium processing device, and an automatic teller machine.

### BACKGROUND

An automatic teller machine is a kind of financial self-service equipment that combines the functions of cash recycling, deposit, withdrawal, temporary storage, sorting, counting, counterfeit identification, end-of-day cash custody and inquiry and so on, and can realize the recycling of various denominations of banknotes in domestic circulation. The automatic teller machine is widely used in banks and other financial fields, providing great convenience for users to conduct business.

The automatic teller machine provided in the related art is provided with a separable transmission mechanism, and the transmission mechanism includes two separable transmission members, for example, a gear and a gear, a gear and a rack, or the like. In such transmission mechanism, when the two transmission members mate with each other, there exists a problem that the fit clearance is unstable and even collision occurs to cause damage during the fit.

### SUMMARY

The present disclosure provides a transmission mechanism, which can solve the problem that the fit clearance between two transmission members of the transmission mechanism provided by the related art is unstable and even collision occurs to cause damage during the fit.

The transmission mechanism provided by the present disclosure includes a first frame, a second frame and a transmission assembly.

The second frame has a first position and a second position relative to the first frame.

The transmission assembly includes a mounting frame, a first transmission member, a second transmission member and an elastic member, where the mounting frame is movably disposed on the first frame, the first transmission member is disposed on the mounting frame, the second transmission member is disposed on the second frame, the elastic member is connected between the mounting frame and the first frame, and the elastic member is configured to enable the mounting frame to drive the first transmission member to move in a set direction, so that the first transmission member is mated with the second transmission member.

When the second frame is at the first position, the first transmission member is drivingly connected to the second transmission member, and the mounting frame abuts against the second frame under the action of the elastic member; and when the second frame is at the second position, the first transmission member is separated from the second transmission member.

The present disclosure also provides a sheet-type medium processing device, which can solve the problem that the fit clearance between two transmission members of the transmission mechanism provided by the related art is unstable and even collision occurs to cause damage during the fit.

The sheet-type medium processing device provided by the present disclosure includes the above transmission mechanism.

The present disclosure also provides an automatic teller machine, which can solve the problem that the fit clearance between two transmission members of the transmission mechanism provided by the related art is unstable and even collision occurs to cause damage during the fit.

The automatic teller machine provided by the present disclosure includes the above transmission mechanism, a passage assembly, a drive assembly, a cash box, a public passage and a processing device which communicates with the public passage, where the processing device, the drive assembly and the public passage are disposed on the first frame of the transmission mechanism, the passage assembly and the cash box are disposed on the second frame of the transmission mechanism, and the drive assembly is drivingly connected to the first transmission member of the transmission mechanism.

The passage assembly includes a first passage plate and a second passage plate, a transport passage is formed between the first passage plate and the second passage plate, two ends of the transport passage form a first access port and a second access port respectively, and the second access port communicates with the cash box. When the second frame is at the first position, the first access port communicates with the public passage; and when the second frame is at the second position, the first access port is separated from the public passage. The second transmission member of the transmission mechanism is disposed on the first passage plate, and the drive assembly is configured to drive the first transmission member to move so as to drive the second transmission member and the first passage plate to move so that the first access port is enlarged and the second access port is shrunk or so that the first access port is shrunk and the second access port is enlarged.

### BRIEF DESCRIPTION OF DRAWINGS

The following is a brief description of accompanying drawings that need to be used in the description of embodiments or the existing art. Apparently, although the accompanying drawings in the following description are some embodiments of the present disclosure, those of ordinary skill in the art are able to obtain other drawings according to the accompanying drawings without the use of inventive faculty.

FIG. 1 is a structure view of a transmission mechanism with a second frame at a first position according to an embodiment of the present disclosure;

FIG. 2 is a partial structure view of a transmission mechanism connected to a drive assembly according to an embodiment of the present disclosure;

FIG. 3 is an exploded view of a transmission mechanism connected to a drive assembly according to an embodiment of the present disclosure;

FIG. 4 is a cross-sectional view of an automatic teller machine according to an embodiment of the present disclosure;

FIG. 5 is a first partial structure view of an automatic teller machine according to an embodiment of the present disclosure;

FIG. 6 is a partial cross-sectional view of an automatic teller machine according to an embodiment of the present disclosure;

FIG. 7 is a second partial structure view of an automatic teller machine according to an embodiment of the present disclosure; and

FIG. 8 is a third partial structure view of an automatic teller machine according to an embodiment of the present disclosure.

### REFERENCE LIST

020 passage assembly
030 cash box
040 banknote-in device
050 banknote-out device
060 temporary storage device
070 identification device
080 public passage
021 first passage plate
022 second passage plate
023 support frame
024 first rotation shaft
025 second rotation shaft
026 first tooth sector
027 second tooth sector
100 first frame
110 movable frame
120 frame body
111 first driving component
112 second driving component
113 guide slot
121 guide member
200 second frame
310 mounting frame
320 elastic member
330 first transmission member
340 second transmission member
311 first end
312 second end
400 pivot shaft
500 support member
600 motor
610 swinging member
620 drive gear
630 transmission gear

### DETAILED DESCRIPTION

The following is a clear and complete description of the technical schemes of the present disclosure in conjunction with embodiments. Apparently, described embodiments are only part, but not all, of the embodiments of the present disclosure.

In the description of embodiments of the present disclosure, it should be noted that the orientational or positional relationships indicated by the terms “above”, “below” and the like are based on the orientational or positional relationships illustrated in the drawings, which are for the mere purpose of facilitating and simplifying the description of the present disclosure and do not indicate or imply that the device or element referred to has a specific orientation and is constructed and operated in a specific orientation, and thus it is not to be construed as limiting the present disclosure.

In the description of the disclosure, it should be noted in the description of the disclosure that unless otherwise specified and restricted, the term “connection” should be understood in a broad sense. For example, the connection may be a fixed connection or may be a removable connection or an integral connection; the connection may be a direct connection or an indirect connection through intermediate media. Those of ordinary skill in the art can understand the meanings of the terms above in the disclosure as the case may be.

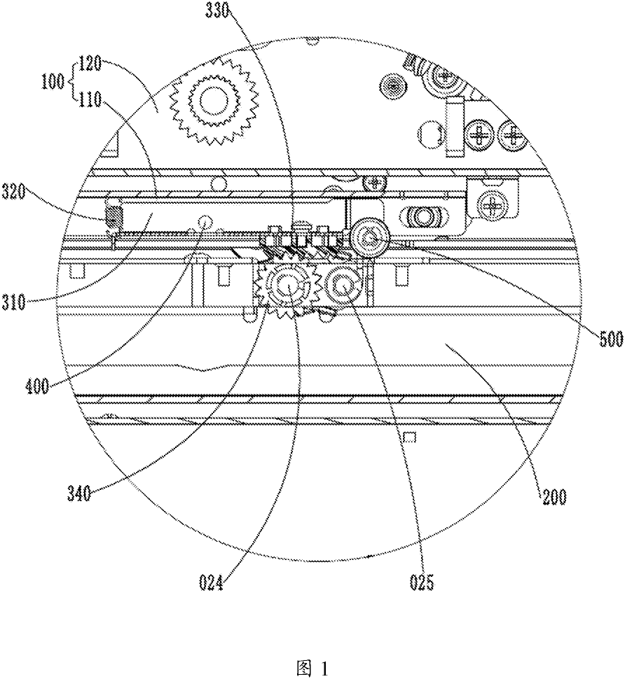

FIG. 1 is a structure view of a transmission mechanism with a second frame at a first position according to an embodiment. As shown in FIG. 1, the embodiment provides a transmission mechanism, including a first frame 100, a second frame 200 and a transmission assembly. In an embodiment, the second frame 200 is movably connected to the first frame 100, and the second frame 200 has a first position and a second position relative to the first frame 100. The transmission assembly includes a mounting frame 310, a first transmission member 330, a second transmission member 340 and an elastic member 320, where the mounting frame 310 is movably disposed on the first frame 100, the first transmission member 330 is disposed on the mounting frame 310, the second transmission member 340 is disposed on the second frame 200, the elastic member 320 is connected between the mounting frame 310 and the first frame 100, and the elastic member 320 is configured to enable the mounting frame 310 to drive the first transmission member 330 to move in a set direction, so that the first transmission member 330 is mated with the second transmission member 340. When the second frame 200 is at the first position (the position shown in FIG. 1), the first transmission member 330 is drivingly connected to the second transmission member 340, and the mounting frame 310 abuts against the second frame 200 under the action of the elastic member 320; and when the second frame 200 is at the second position, the first transmission member 330 is separated from the second transmission member 340.

When the first transmission member 330 just starts to contact the second transmission member 340, the first transmission member 330 will drive the mounting frame 310 to move against the elastic force of the elastic member 320. During this process, the elastic member 320 provides a cushion for the collision between the first transmission member 330 and the second transmission member 340, thereby avoiding a rigid collision between the first transmission member 330 and the second transmission member 340 and reducing the risk of damage to the first transmission member 330 and the second transmission member 340. After the first transmission member 330 is completely mated with the second transmission member 340, the first transmission member 330 is in close fit with the second transmission member 340 and the mounting frame 310 abuts against the second frame 200 under the action of the elastic member 320, to ensure a stable fit clearance between the first transmission member 330 and the second transmission member 340, thus ensuring the transmission stability between the first transmission member 330 and the second transmission member 340.

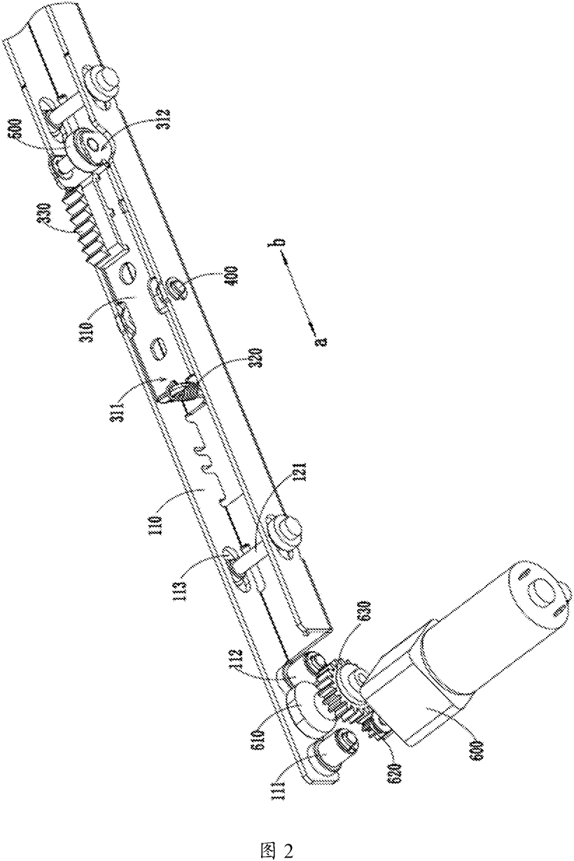

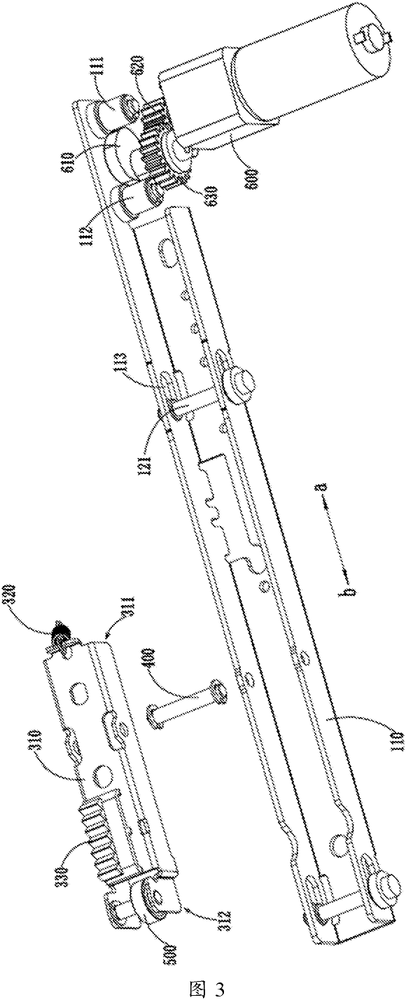

FIG. 2 is a partial structure view of a transmission mechanism connected to a drive assembly according to the embodiment, and FIG. 3 is an exploded view of a transmission mechanism connected to a drive assembly according to the embodiment. Continuing to refer to FIG. 1 in conjunction with FIGS. 2 and 3, in the embodiment, the mounting frame 310 is pivotally connected to the first frame 100 through a pivot shaft 400, a first end of the elastic member 320 is connected to the mounting frame 310, a second end of the elastic member 320 is connected to the first frame 100, and when the second frame 200 is at the first position, an end of the mounting frame 310 abuts against the second frame 200. The elastic member 320 enables the mounting frame 310 to have a rotation tendency to drive the first transmission member 330 to be mated with the second transmission member 340, that is, the tendency to move along the set direction. In this manner, the structure is simple, and the rotation of the mounting frame 310 enables the end of the mounting frame 310 to abut against the second frame 200, which features small space occupation and compact structure.

In other embodiments, one of a first frame 100 or a mounting frame 310 is provided with a long groove extending along a set direction, the other one of the first frame 100 or the mounting frame 310 is provided with a post, and the post is configured to be in plug-in fit with the long groove, so that the mounting frame 310 can move relative to the first frame 100 along the length direction of the long groove. An elastic member 320 is connected between the mounting frame 310 and the first frame 100, and the elastic member 320 is configured to enable the mounting frame 310 to drive the first transmission member 330 to move in the set direction. When the second frame 200 is at the first position (the position shown in FIG. 1), the first transmission member 330 is drivingly connected to the second transmission member 340, and the mounting frame 310 abuts against the second frame 200 under the action of the elastic member 320; and when the second frame 200 is at the second position, the first transmission member 330 is separated from the second transmission member 340. Optionally, when the second frame 200 is at the second position, the mounting frame 310 is separated from the second frame 200.

In the embodiment, the elastic member 320 is a tension spring. In other embodiments, the elastic member 320 may be a compression spring, a torsion spring, or the like.

Continuing to refer to FIGS. 1 to 3, in the embodiment, the length of the mounting frame 310 extends along a first direction, the mounting frame 310 includes a first end 311 and a second end 312 which are sequentially disposed along the first direction, the axial direction of the pivot shaft 400 is disposed at an angle relative to the first direction, and the pivot shaft 400 is located between the first end 311 of the mounting frame 310 and the second end 312 of the mounting frame 310. The elastic member 320 is connected to the first end 311 of the mounting frame 310, and the second end 312 of the mounting frame 310 is provided with a support member 500. When the second frame 200 is at the first position, the support member 500 abuts against the second frame 200, so that it is achieved that the mounting frame 310 abuts against the second frame 200.

When the first transmission member 330 just starts to contact the second transmission member 340, the first transmission member 330 will drives the mounting frame 310 to rotate around the pivot shaft 400 against the elastic force of the elastic member 320. At this time, under the action of the elastic member 320, the first end 311 of the mounting frame 310 approaches the first frame 100 and the second end 312 of the mounting frame 310 moves in a direction toward the second frame 200. After the first transmission member 330 is completely mated with the second transmission member 340, the support member 500 disposed on the second end 312 of the mounting frame 310 abuts against the second frame 200, so that there is a stable fit clearance between the first transmission member 330 and the second transmission member 340, ensuring the reliability of the power transmission between the first transmission member 330 and the second transmission member 340.

Continuing to refer to FIGS. 2 and 3, in the embodiment, the first transmission member 330 is located between the support member 500 and the pivot shaft 400, and the first transmission member 330 is disposed close to the support member 500. The second frame 200 switches between the first position and the second position along the first direction (i.e., a direction of an arrow a, and a direction of an arrow b in FIGS. 2 and 3). When moving in the direction indicated by the arrow a, the second frame 200 moves towards the second position. When moving in the direction indicated by the arrow b, the second frame 200 moves towards the first position.

In this manner, during the working process of the transmission mechanism, an engagement relationship between the second transmission member 340 and the first transmission member 330 can be always maintained. During the movement of the second frame 200 from the second position to the first position, the support member 500 firstly abuts against the second frame 200 or the second transmission member 340 to allow the mounting frame 310 to rotate against the elastic force of the elastic member 320, so that the first transmission member 330 avoids the second transmission member 340. When the second frame 200 reaches the first position, the mounting frame 310 also moves under the action of the elastic member 320, and the support member 500 abuts against the second frame 200, so that the first transmission member 330 is mated with the second transmission member 340 reliably, avoiding the collision between the first transmission member 330 and the second transmission member 340.

Optionally, a positioning groove may be provided on the surface of the second frame 200, and the positioning groove is disposed close to the second transmission member 340. During the movement of the second frame 200 from the second position to the first position, the support member 500 firstly abuts against the surface of the second frame 200, so that the first transmission member 330 avoids the second transmission member 340. When the second frame 200 reaches the first position, the support member 500 is located in the positioning groove, so that the first transmission member 330 and the second transmission member 340 can be positioned reliably. The mounting frame 310 can be ensured to rotate under the action of the elastic member 320, so that the first transmission member 330 is mated with the second transmission member 340 reliably, avoiding the collision between the first transmission member 330 and the second transmission member 340 during the movement of the second frame 200 towards the first position.

Continuing to refer to FIGS. 1 to 3, in the embodiment, the first transmission member 330 is a rack and the second transmission member 340 is a gear; the first frame 100 includes a frame body 120 and a movable frame 110 movably disposed on the frame body 120, the mounting frame 310 is movably disposed on the movable frame 110, and the elastic member 320 is connected between the mounting frame 310 and the movable frame 110; the frame body 120 is also provided with a drive assembly, the drive assembly is drivingly connected to the movable frame 110 or the first transmission member 330, and the drive assembly is configured to drive the first transmission member 330 to move, so that the first transmission member 330 drives the second transmission member 340 to move. In the embodiment, the drive assembly is drivingly connected to the movable frame 110 and is used for driving the movable frame 110 to move in the first direction, so that the first transmission member 330 drives the second transmission member 340 to move. In an embodiment, the drive assembly includes a motor 600, the motor 600 is drivingly connected to the movable frame 110, and the motor 600 is configured to drive the movable frame 110 to move in the first direction, so that the first transmission member 330 (which is the rack) drives the second transmission member 340 (which is the gear) to rotate.

When the transmission mechanism is in operation, the motor 600 is activated to drive the movable frame 110 to move along the extension direction of the rack, thereby driving the gear which meshes with the rack to rotate. In this way, the power transmission from the first transmission member 330 to the second transmission member 340 is achieved. The first frame 100 is provided to include a frame body 120 and a movable frame 110, so that during the working process of the transmission mechanism provided in the embodiment, the motor 600 drives only the movable frame 110 to move, without the need to drive the entire first frame 100, reducing the requirement of the motor 600 on the load.

In other embodiments, the first transmission member 330 may be provided as a gear, and the second transmission member 340 may be provided as a rack. Such configuration also utilizes the meshing between the gear and the rack to achieve the power transmission. Of course, the first transmission member 330 and the second transmission member 340 may also be provided as gears at the same time, and the power transmission is achieved by the meshing between the gears. In an embodiment, the first transmission member 330 may be provided as a cam, and the second transmission member 340 may be provided as a circular transmission wheel. In this way, intermittent rotation drive of the circular transmission wheel is achieved by using the frictional force between the outer contour of the cam and the outer circumferential surface of the circular transmission wheel. In the embodiment, the working process of the transmission mechanism is only exemplarily described by taking the first transmission member 330 as the rack and the second transmission member 340 as the gear.

In other embodiments, the first transmission member 330 may be provided as a gear, and the second transmission member 340 may be provided as a rack or a gear. The drive assembly is drivingly connected to the gear to drive the gear to rotate, and the rotating gear drives the rack to move or drives the gear to rotate. In an embodiment, a first pulley is fixedly sleeved on the pivot shaft 400, and the first transmission member is coaxially and fixedly connected to a second pulley. The drive assembly includes a motor and a driving belt, the driving belt is sleeved on the first pulley and the second pulley, and the motor is drivingly connected to the first pulley. When the motor drives the first pulley to rotate, the driving belt drives the second pulley to rotate and the second pulley drives the first transmission member to rotate.

Optionally, when the first transmission member 330 is a rack, the extension direction of the rack is the first direction, that is, the extension direction of the rack is the same as the length direction of the mounting frame 310.

Optionally, the support member 500 is a roller. In this manner, the support member 500 is configured to be in rolling fit with the second frame 200. When the motor 600 drives the movable frame 110 to move in the first direction so as to drive the second transmission member 340 to rotate, the support member 500 rolls on the second frame 200, not only reducing the friction force between the support member 500 and the second frame 200 but also reducing the noise during the working process of the transmission mechanism provided in the embodiment.

Continuing to refer to FIGS. 1 to 3, in the embodiment, the movable frame 110 is provided with a first driving component 111 and a second driving component 112 which are spaced apart from each other along the first direction, an output shaft of the motor 600 is connected to a swinging member 610, the swinging member 610 is located between the first driving component 111 and the second driving component 112, and the motor 600 is configured to drive the swinging member 610 to cooperate with the first driving component 111 or the second driving component 112 so that the movable frame 110 is driven to reciprocate along the first direction. In an embodiment, the first driving component 111 and the second driving component 112 are disposed at an end of the movable frame 110, and the first driving component 111 is disposed away from the mounting frame 310, that is, the first driving component 111 and the second driving component 112 are disposed in sequence along the direction indicated by the arrow b.

When the transmission mechanism is used to transmit power, the motor 600 is activated to drive the swinging member 610 to swing. When the movable frame 110 needs to move in the direction indicated by the arrow a, the swinging member 610 cooperates with the first driving component 111; and when the movable frame 110 needs to move in the direction indicated by the arrow b, the swinging member 610 cooperates with the second driving component 112. In this manner, the reciprocation of the movable frame 110 along the first direction is achieved.

In an embodiment, the swinging member 610 is a cam plate, and the cam plate is drivingly connected to the output shaft of the motor 600. When the output shaft of the motor 600 rotates, the outer contour of the cam plate cooperates with the first driving component 111 or the second driving component 112 to drive the movable frame 110 to reciprocate along the first direction. Of course, the swinging member 610 may also be a round plate, and the round plate is drivingly connected to the output shaft of the motor 600 at an eccentric position of the round plate.

Continuing to refer to FIGS. 2 and 3, a drive gear 620 is fixedly sleeved on the output shaft of the motor 600, a transmission gear 630 is fixedly disposed on the swinging member 610, and the transmission gear 630 meshes with the drive gear 620, thereby enabling the motor 600 to drive the swinging member 610.

In other embodiments, a rack is fixedly disposed on the movable frame 110 and extends along the first direction, and a drive gear 620 is fixedly sleeved on the output shaft of the motor 600 and meshes with the rack. When the output shaft of the motor 600 rotates in a forward direction, the drive gear 620 drives the rack to allow the movable frame 110 to move along the direction indicated by the arrow a. When the output shaft of the motor 600 rotates in a reverse direction, the drive gear 620 drives the rack to allow the movable frame 110 to move along the direction indicated by the arrow b.

Continuing to refer to FIG. 2 and FIG. 3, in the embodiment, multiple guide members 121 are disposed on the frame body 120 of the first frame 100, and the multiple guide members 121 are disposed at intervals along the first direction. Correspondingly, the movable frame 110 is provided with multiple strip-shaped guide slots 113. The length direction of each guide slot 113 extends along the first direction, and the multiple guide members 121 are configured to be in plug-in fit with the multiple guide slots 113 in a one-to-one correspondence. Such configuration realizes the guidance for the reciprocation of the movable frame 110, ensures the reliability of the movement of the movable frame 110 and avoids the damage of the first transmission member 330 and the second transmission member 340 due to the displacement of the movable frame 110.

The embodiment also provides a sheet-type medium processing device, including the above transmission mechanism. Correspondingly, the sheet-type medium processing device has all the advantages of the above-mentioned transmission mechanism and therefore will not be repeated here.

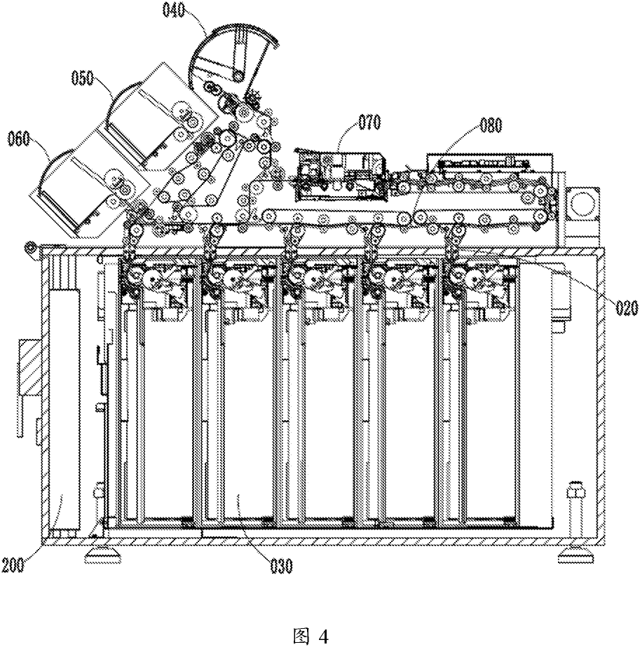

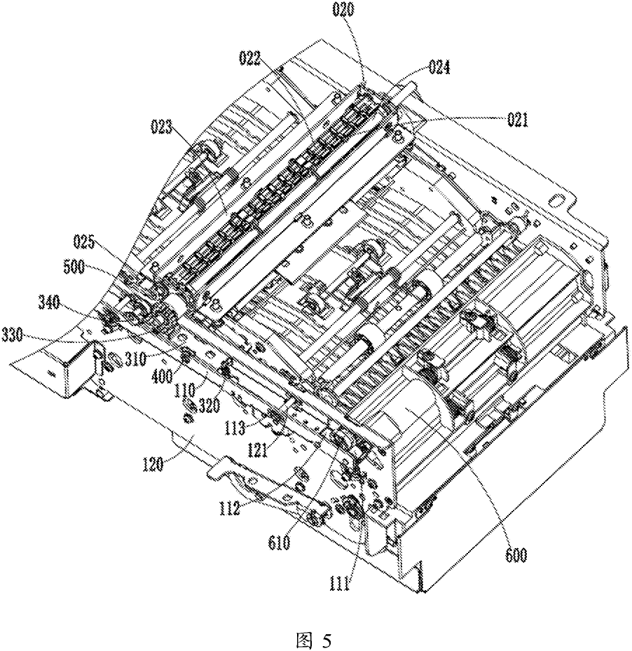

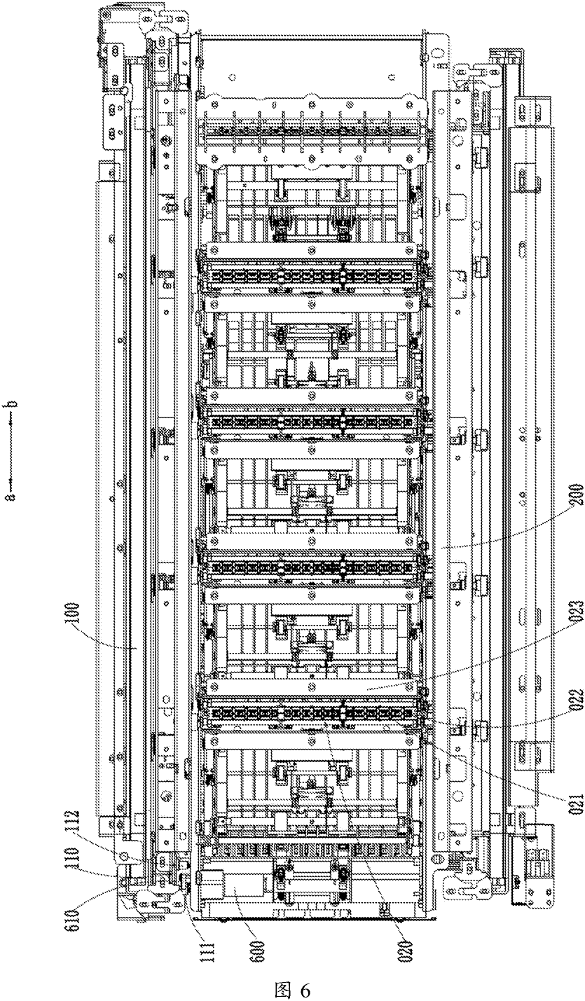

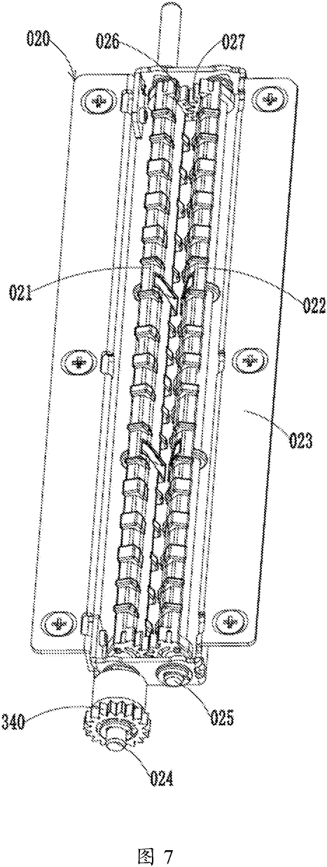

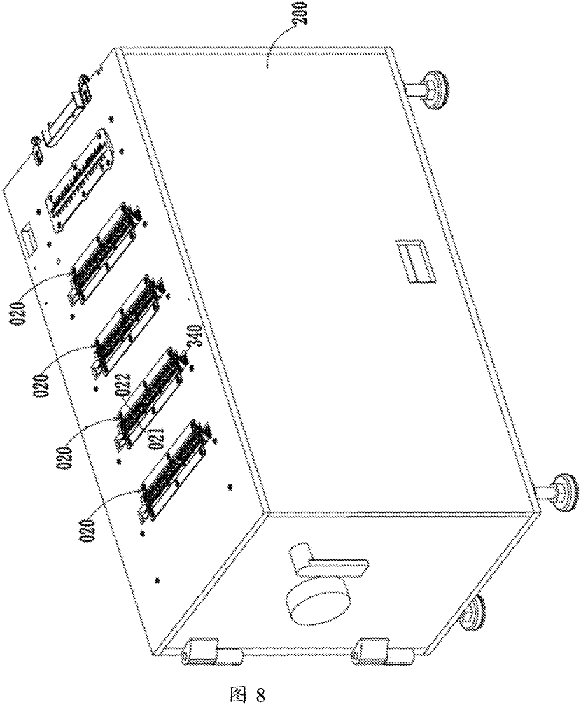

FIG. 4 is a cross-sectional view of an automatic teller machine according to the embodiment, FIG. 5 is a first partial structure view of the automatic teller machine according to the embodiment, FIG. 6 is a partial cross-sectional view of the structure of the automatic teller machine according to the embodiment, FIG. 7 is a second partial structure view of the automatic teller machine according to the embodiment, and FIG. 8 is a third partial structure view of the automatic teller machine according to the embodiment. As shown in FIGS. 4 to 8, the embodiment also provides an automatic teller machine, in which the above-mentioned transmission mechanism is provided. Correspondingly, the automatic teller machine has all the advantages of the above-mentioned transmission mechanism and will not be repeated here.

Continuing to refer to FIG. 4, in the embodiment, the automatic teller machine further includes a banknote-in device 040, a banknote-out device 050, a temporary storage device 060, an identification device 070, a public passage 080 and a safe. The banknote-in device 040, the banknote-out device 050, the temporary storage device 060 and the identification device 070 all belong to processing devices of the automatic teller machine. Each of the above processing devices communicates with the public passage 080, and multiple cash boxes 030 are disposed in the safe.

The basic working process of the automatic teller machine can be as follows: in depositing, banknotes enter from the banknote-in device 040, and after being identified by the identification device 070, banknotes that meet the requirement enter the temporary storage device 060 through the public passage 080 and wait for a user’ confirmation. If a user confirms the deposit, the banknotes in the temporary storage device 060 are conveyed to the identification device 070 from the public passage 080 for further identification and counting. Then, the banknotes are conveyed to a corresponding cash box 030 in the safe for storage according to the identification results such as the denomination, whether it is suitable for circulation and the like, and at the same time unqualified banknotes are conveyed to the banknote-out device 050 for the user to take away. In withdrawing, banknotes enter the public passage 080 from a cash box 030 and are then conveyed to the identification device 070 for identification, where qualified banknotes are conveyed to the banknote-out device 050 for the user to take away, and unqualified banknotes are again returned to a cash box 030 dedicated to recycling in the safe for storage.

It should be noted that the structure and working process of the automatic teller machine may be the related art well known to those skilled in the art, which are not improved in the embodiment and thus will not be repeated.

In an embodiment, continuing to refer to FIGS. 4 to 6, a banknote-in device 040, a banknote-out device 050, a temporary storage device 060 and an identification device 070 together form an upper unit of the automatic teller machine, a safe and cash boxes 030 in the safe together form a lower unit of the automatic teller machine, and the upper unit is slidably connected to the lower unit. When maintenance of the upper unit is required, the upper unit can be pulled out relative to the lower unit; and when the maintenance is finished, the upper unit will be pushed back over the lower unit. The automatic teller machine provided in the embodiment further includes a passage assembly 020 and a drive assembly. The drive assembly and the upper unit are disposed on the first frame 100, the drive assembly is drivingly connected to the first transmission member 330 of the transmission mechanism, the safe may be provided as the second frame 200 of the transmission mechanism, and the passage assembly 020 and the cash boxes 030 are disposed in the safe. The drive assembly includes the motor 600 and the swinging member 610 described above.

When the upper unit is pushed back relative to the lower unit, the support member 500 of the transmission mechanism can firstly contact the second transmission member 340, and the support member 500 overcomes the elastic force to avoid the second transmission member 340. Then, when the second frame 200 is at the first position, the second transmission member 340 will contact the first transmission member 330. In the case where the first transmission member 330 is a rack and the second transmission member 340 is a gear, this arrangement can prevent the collision between the rack and the gear.

In conjunction with FIGS. 7 and 8, the passage assembly 020 includes a first passage plate 021 and a second passage plate 022, a conveyance passage is formed between the first passage plate 021 and the second passage plate 022, two ends of the conveyance passage form a first access port and a second access port respectively, and the second access port communicates with a cash box 030. When the second frame 200 is at the first position, the first access port communicates with the public passage 080; when the second frame 200 is at the second position, the first access port is separated from the public passage 080. The second transmission member 340 of the transmission mechanism is disposed on the first passage plate 021, and the drive assembly is configured to cause the first transmission member 330 to drive the second transmission member 340 to move so that the first access port is enlarged and the second access port is shrunk or so that the first access port is shrunk and the second access port is enlarged.

During the working process of the automatic teller machine, in depositing, the second frame 200 is at the first position such that the first transmission member 330 is mated with the second transmission member 340, and the motor 600 is activated to rotate the drive gear 620 to drive the transmission gear 630 which meshes with the drive gear 620 to rotate, thereby realizing the swinging of the swinging member 610. In an embodiment, when banknotes enter a cash box 030 from the public passage 080, the swinging member 610 cooperates with the second driving component 112, and the movable frame 110 moves in the direction shown by the arrow a in FIG. 6, so that the first access port is enlarged (the upper end has an open port) and the second access port is shrunk (the lower end has a shrunk port), so that the banknotes conveyed through the public passage 080 enter a conveyance passage via the first access port and then enter the cash box 030 from the smaller second access port of the lower end, thereby finishing the depositing. Since the first access port is larger, it is convenient for the banknotes to enter the conveyance passage smoothly via the first access port, and since the second access port is smaller, the second access port can be accurately aligned with an access port of the cash box 030, so that the banknotes in the conveyance passage can also enter the cash box 030 smoothly via the second access port; when banknotes enter the public passage 080 from the cash box 030, under the action of the motor 600, the swinging member 610 cooperates with the first driving component 111 to allow the movable frame 110 to move in the direction shown by an arrow b in FIG. 6, so that the first access port is shrunk (the upper end has a shrunk port) and the second access port is enlarged (the lower end has an open port), so that the banknotes in the cash box 030 smoothly enter the conveyance passage via the second access port and are then conveyed to the public passage 080 via the first access port, thereby finishing the withdrawing. Since the second access port is larger, it is convenient for the banknotes in the cash box 030 to enter the conveyance passage smoothly via the second access port, and since the first access port is smaller, the first access port can be accurately aligned with the public passage 080 so that the banknotes in the conveyance passage can also enter the public passage 080 smoothly via the first access port.

In the automatic teller machine, the above-mentioned transmission mechanism is provided to ensure the reliable transmission of the power of the motor 600 to the first passage plate 021 during the banknote-in process and the banknote-out process, thereby ensuring the reliability of the movement of the first passage plate 021 and ensuring that the banknote-in and banknote-out operation are smoothly carried out.

Optionally, the first passage plate 021 is drivingly connected to the second passage plate 022, where the first passage plate 021 is fixedly provided with a first rotation shaft 024, and the first rotation shaft 024 is provided with a first tooth sector 026; and the second passage plate 022 is fixedly provided with a second rotation shaft 025, the second rotation shaft 025 is provided with a second tooth sector 027, and the first tooth sector 026 is mated with the second tooth sector 027. In this manner, when the motor 600 drives the first passage plate 021 to rotate around the first rotation shaft 024, the first tooth sector 026 meshes with the second tooth sector 027 for transmission, thereby driving the second passage plate 022 to rotate synchronously and reversely around the second rotation shaft 025. In this manner, it is achieved that the upper end of the first passage plate 021 and the upper end of the second passage plate 022 simultaneously get close to or away from each other, and the lower end of the first passage plate 021 and the lower end of the second passage plate 022 simultaneously get close to or away from each other.

Continuing to refer to FIG. 5 and FIG. 7, in the embodiment, the passage assembly 020 may further include a support frame 023, and the support frame 023 is fixed to the safe. The first passage plate 021 is pivotally connected to the support frame 023 through the first rotation shaft 024, and the second passage plate 022 is pivotally connected to the support frame 023 through the second rotation shaft 025. In this manner, the modularization of the passage assembly 020 is achieved, which facilitates the assembly.

Continuing to refer to FIG. 4, FIG. 6 and FIG. 8, in the embodiment, the automatic teller machine includes multiple passage assemblies 020 and multiple cash boxes 030, the transmission mechanism includes multiple transmission assemblies, the multiple transmission assemblies are arranged in one-to-one correspondence with the multiple passage assemblies 020, and second access ports of the multiple passage assemblies 020 communicate with the multiple cash boxes 030 in a one-to-one correspondence. When the second frame 200 is at the first position, a first transmission member 330 of each transmission assembly is drivingly connected to a respective second transmission member 340. The above arrangement enables each of the multiple cash boxes 030 to store and distribute banknotes, which greatly increases the processing capacity of the automatic teller machine in the embodiment.

What is claimed is:

1. A transmission mechanism, comprising:
a first frame (100);
a second frame (200) having a first position and a second position relative to the first frame (100); and
a transmission assembly comprising a mounting frame (310), a first transmission member (330), a second transmission member (340) and an elastic member (320), wherein the mounting frame (310) is movably disposed on the first frame (100), the first transmission member (330) is disposed on the mounting frame (310), the second transmission member (340) is disposed on the second frame (200), the elastic member (320) is connected between the mounting frame (310) and the first frame (100), and the elastic member (320) is configured to enable the mounting frame (310) to drive the first transmission member (330) to move in a set direction, so that the first transmission member (330) is mated with the second transmission member (340),
wherein when the second frame (200) is at the first position, the first transmission member (330) is drivingly connected to the second transmission member (340) and the mounting frame (310) abuts against the second frame (200) under action of the elastic member (320); and when the second frame (200) is at the second position, the first transmission member (330) is separated from the second transmission member (340).

2. The transmission mechanism of claim 1, wherein the mounting frame (310) is pivotally connected to the first frame (100) through a pivot shaft (400), a first end of the elastic member (320) is connected to the mounting frame (310), a second end of the elastic member (320) is connected to the first frame (100), and when the second frame (200) is at the first position, an end of the mounting frame (310) abuts against the second frame (200).

3. The transmission mechanism of claim 2, wherein a length of the mounting frame (310) extends along a first direction, the mounting frame (310) comprises a first end (311) and a second end (312) which are sequentially disposed along the first direction, an axial direction of the pivot shaft (400) is disposed at an angle relative to the first direction, and the pivot shaft (400) is located between the first end (311) of the mounting frame (310) and the second end (312) of the mounting frame (310); and wherein the elastic member (320) is connected to the first end (311) of the mounting frame (310), the second end (312) of the mounting frame (310) is provided with a support member (500), and when the second frame (200) is at the first position, the second end (312) of the mounting frame (310) abuts against the second frame (200) through the support member (500).

4. The transmission mechanism of claim 3, wherein the first transmission member (330) is located between the support member (500) and the pivot shaft (400), and the first transmission member (330) is disposed close to the support member (500).

5. The transmission mechanism of claim 1, wherein the first transmission member (330) is one of a gear or a rack, and the second transmission member (340) is the other one of the gear or the rack;
or, both the first transmission member (330) and the second transmission member (340) are gears.

6. The transmission mechanism of any one of claims 1 to 5, wherein the first frame (100) comprises a frame body (120) and a movable frame (110) movably disposed on the frame body (120), the mounting frame (310) is movably disposed on the movable frame (110), and the elastic member (320) is connected between the mounting frame (310) and the movable frame (110); and
wherein the frame body is further provided with a drive assembly, the drive assembly is drivingly connected to the movable frame (110), a length of the mounting frame (310) extends along the first direction, and the drive assembly is configured to drive the movable frame (110) to move in the first direction so that the first transmission member (330) drives the second transmission member (340) to move.

7. The transmission mechanism of claim 6, wherein the movable frame (110) is provided with a first driving component (111) and a second driving component (112) which are spaced apart from each other along the first direction, the drive assembly comprises a motor (600) and a swinging member (610) which is drivingly connected to an output shaft of the motor (600), the swinging member (610) is located between the first driving component (111) and the second driving component (112), and the motor (600) is configured to drive the swinging member (610) to cooperate with the first driving component (111) or the second driving component (112), so that the movable frame (110) is driven to reciprocate along the first direction.

8. A sheet-type medium processing device, comprising the transmission mechanism of any one of claims 1 to 5.

9. An automatic teller machine, comprising: the transmission mechanism of any one of claims 1 to 5, a passage assembly (020), a drive assembly, a cash box (030), a public passage (080) and a processing device which communicates with the public passage (080), wherein the processing device, the drive assembly and the public passage (080) are disposed on the first frame (100) of the transmission mechanism, the passage assembly (020) and the cash box (030) are disposed on the second frame (200) of the transmission mechanism, and the drive assembly is drivingly connected to the first transmission member (330) of the transmission mechanism; and
wherein the passage assembly (020) comprises a first passage plate (021) and a second passage plate (022), a conveyance passage is formed between the first passage plate (021) and the second passage plate (022), two ends of the conveyance passage form a first access port and a second access port respectively, and the second access port communicates with the cash box (030); when the second frame (200) is at the first position, the first access port communicates with the public passage (080); when the second frame (200) is at the second position, the first access port is separated from the public passage (080); and the second transmission member (340) of the transmission mechanism is disposed on the first passage plate (021), and the drive assembly is configured to drive the first transmission member (330) to move so as to drive the second transmission member (340) and the first passage plate (021) to move so that the first access port is enlarged and the second access port is shrunk or so that the first access port is shrunk and the second access port is enlarged.

10. The automatic teller machine of claim 9, wherein the automatic teller machine comprises a plurality of passage assemblies (020) and a plurality of cash boxes (030), the transmission mechanism comprises a plurality of transmission assemblies, the plurality of transmission assemblies are arranged in one-to-one correspondence with the plurality of passage assemblies (020), and second access ports of the plurality of passage assemblies (020) communicate with the plurality of cash boxes (030) in a one-to-one correspondence; and
wherein when the second frame (200) is at the first position, a first transmission member (330) of each of the plurality of transmission assemblies is drivingly connected to a respective second transmission member (340).
